(19) United States
(12) Patent Application Publication
(10) Pub. No.: US 2014/0345593 A1
(43) Pub. Date: Nov. 27, 2014

(54) THROUGH-TYPE BARBECUE DRIVING DEVICE ALLOWING ARBITRARY ADJUSTMENT OF INSTALLATION POSITION OF ROTATING ROD

(71) Applicant: Huang-Hsi HSU, Taipei City, (TW)

(72) Inventor: Huang-Hsi HSU, Taipei City, (TW)

(21) Appl. No.: 14/078,865

(22) Filed: Nov. 13, 2013

(30) Foreign Application Priority Data
May 21, 2013 (TW) 102209410

(51) Int. Cl. A47J 37/04; A47J 37/07

(52) U.S. Cl. CPC A47J 37/041; A47J 37/0745
USPC 126/25 AA; 99/421 HV

(57) ABSTRACT

The present invention is to provide a through-type barbecue driving device which includes a housing fixedly installed at a top edge on one side of a barbecue stove, a motor positioned in the housing and provided with an output shaft at one end, a drive gear set positioned in the housing and rotated by the output shaft when the motor is in operation, and an output gear positioned in the housing and meshing with the drive gear set. The housing has two through holes formed at two opposite sides thereof, respectively. The output gear has a gear shaft axially penetrated by a through groove, which corresponds in position to the two through holes and matches a rotating rod in terms of configuration, thus allowing the rotating rod to pass through the two through holes and the through groove and then engage with the through groove in an arbitrary installation position.

### FIELD OF THE INVENTION

The present invention is to provide a through-type barbecue driving device which includes a housing fixedly installed at a top edge on one side of a barbecue stove, a motor positioned in the housing and provided with an output shaft at one end, a drive gear set positioned in the housing and rotated by the output shaft when the motor is in operation, and an output gear positioned in the housing and meshing with the drive gear set. The housing has two through holes formed at two opposite sides thereof, respectively. The output gear has a gear shaft axially penetrated by a through groove, which corresponds in position to the two through holes and matches a rotating rod in terms of configuration, thus allowing the rotating rod to pass through the two through holes and the through groove and then engage with the through groove. Once the through-type barbecue driving device begins operation, the output shaft of the motor sequentially drives the drive gear set and the output gear such that the rotating rod is rotated along with the output gear and above the barbecue stove. As the rotating rod passes through the output gear, the position of the rotating rod relative to the through groove can be easily adjusted to eliminate any mismatch in size between the rotating rod and the barbecue stove.

### BACKGROUND OF THE INVENTION

Recently, with the rapid development of economy, people are increasingly better off and, in addition to pursuing material enjoyment, pay more and more attention to recreational activities, one very common example of which is the barbecue. Typically held outdoors, barbecues are a perfect activity in which family members or group members can take part and which therefore serves both recreational and social functions.

As barbecues become progressively popular, the variety of food to be barbecued increases too, including such large items as whole chickens, piglets, and even whole goats. In order to roast these bulky, heavy food items with ease and ensure uniform heating, electric barbecue stoves—which use a motor to rotate the food placed on a grill rack or skewered on a spit—have been developed and brought to the market. FIG. 1 illustrates the driving device 1 of a conventional electric barbecue stove, wherein the driving device 1 is provided therein with a motor 11, and the output shaft 110 of the motor 11 is formed with a positioning groove 110a. To use an electric barbecue stove (not shown) configured for the driving device 1, the driving device 1 is installed on one side of the barbecue stove, and a grill rack or spit is inserted at one end into the positioning groove 110a, with the other end of the grill rack or spit placed on a supporting element on the other side of the barbecue stove, thereby keeping the grill rack or spit above the barbecue stove. When the motor 11 is in operation, the grill rack or spit is driven by the motor 11 to rotate above the barbecue stove.

However, the major drawback of such electric barbecue stoves is that the size of the grill rack (or spit) to be used must match that of the stove to ensure that the food to be cooked corresponds in position to the heat source in the stove. If the grill rack is too large, it is very likely that some of the food on the grill rack is away from the heat source or even extends out of the stove. If the grill rack is too small, the end of the grill rack that is opposite the end connected with the driving device may have problem being propped by the supporting element, and the grill rack may be slanted or even shifted in place as a result. As commercially available electric barbecue stoves are not necessarily sold with an accompanying grill rack, and it is not uncommon for a consumer to buy several grill racks or spits to suit differently sized food items, a mismatch in size is highly probable between the barbecue stove and grill racks to be used and, if present, may spoil the enjoyment of the activity.

Although improvements have been made to enable barbecue stoves to adapt to grill racks or spits of various sizes, the improved barbecue strove structures incur high production costs and are too complicated for intuitive use. In the light of this, the inventor strived to make further improvements on the driving device of a barbecue stove in order to solve the problem of having a grill rack or spit whose size does not match the size of the barbecue stove being used. The issue to be addressed by the present invention, therefore, is to design an improved structure for the driving device of a barbecue stove.

### BRIEF SUMMARY OF THE INVENTION

In view of the fact that a mismatch in size between a grill rack and a barbecue stove tends to prevent the grill rack from being stably positioned, the inventor of the present invention incorporated years of practical experience into continual research, improvement, and trials and finally succeeded in developing a through-type barbecue driving device which allows the installation position of a rotating rod to be adjusted as desired. The present invention is intended to eliminate the various inconveniences associated with the conventional barbecue stoves.

It is an object of the present invention to provide a through-type barbecue driving device which allows arbitrary adjustment of the installation position of a rotating rod. The through-type barbecue driving device is applied to a barbecue stove and includes a housing, a motor, a drive gear set, and an output gear. The housing defines a receiving space therein and is fixedly installed at a top edge on one side of the barbecue stove. The housing has one side facing the barbecue stove and formed with a first through hole, and the opposite side of the housing is provided with a second through hole corresponding in position to the first through hole. The through holes are in communication with the receiving space. The motor is positioned in the receiving space and is provided with an output shaft at one end. The drive gear set at least includes a drive gear, wherein the drive gear has an axle provided with a connecting portion connected with the output shaft. The output shaft can drive the drive gear into rotation when the motor is in operation. The output gear is positioned in the receiving space and is adjacent to the drive gear set in order to mesh with the drive gear set. The output gear has a gear shaft axially penetrated by a through groove. The through groove corresponds in position to the first and the second through holes and matches a rotating rod in terms of configuration, thus allowing the rotating rod to pass sequentially through the first through hole, the through groove, and the second through hole and engage with the through groove. Once the through-type barbecue driving device begins operation, the output shaft of the motor sequentially drives the drive gear set and the output gear such that the rotating rod is rotated along with the output gear and above the barbecue stove. As the rotating rod passes through the output gear, the position of the rotating rod relative to the through groove can be easily adjusted to eliminate any mismatch in size between the rotating rod and the barbecue stove.

### BRIEF DESCRIPTION OF THE SEVERAL VIEWS OF THE DRAWINGS

The technical means, structural features, and objects of the present invention will be best understood by referring to the following detailed description of some illustrative embodiments in conjunction with the accompanying drawings, in which:

FIG. 1 schematically shows a conventional driving device for a barbecue stove;

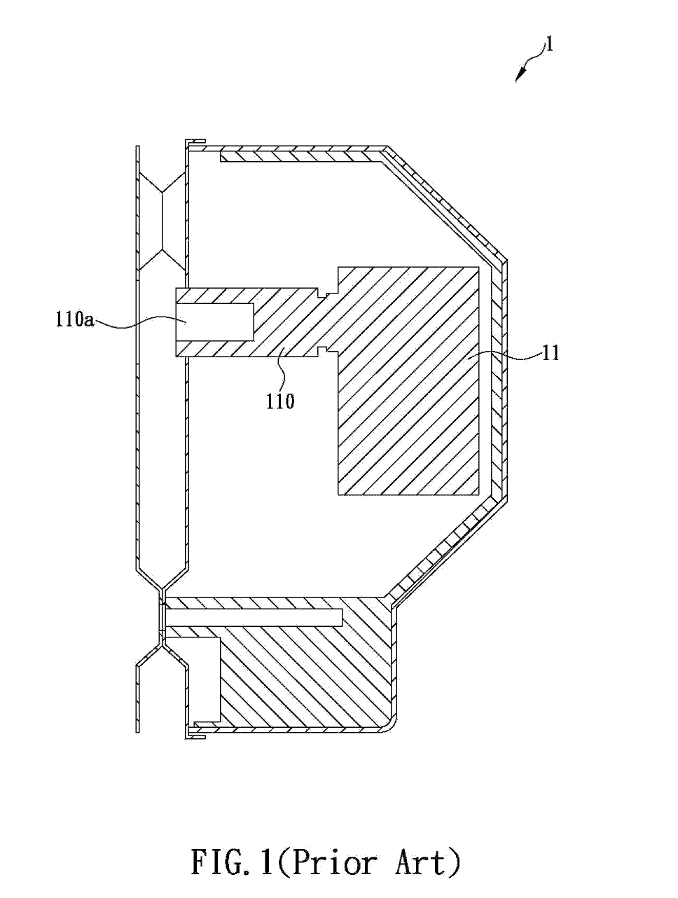

FIG. 2 is a perspective view of a through-type barbecue driving device of the present invention and a barbecue stove;

FIG. 3 is a sectional perspective view of the through-type barbecue driving device according to the first preferred embodiment of the present invention;

FIG. 4 is a sectional view of the through-type barbecue driving device according to the second preferred embodiment of the present invention;

FIG. 5 is a sectional view of the through-type barbecue driving device according to the third preferred embodiment of the present invention; and

FIG. 6 is a perspective view of a positioning element for use in a through-type barbecue driving device of the present invention.

### DETAILED DESCRIPTION OF THE INVENTION

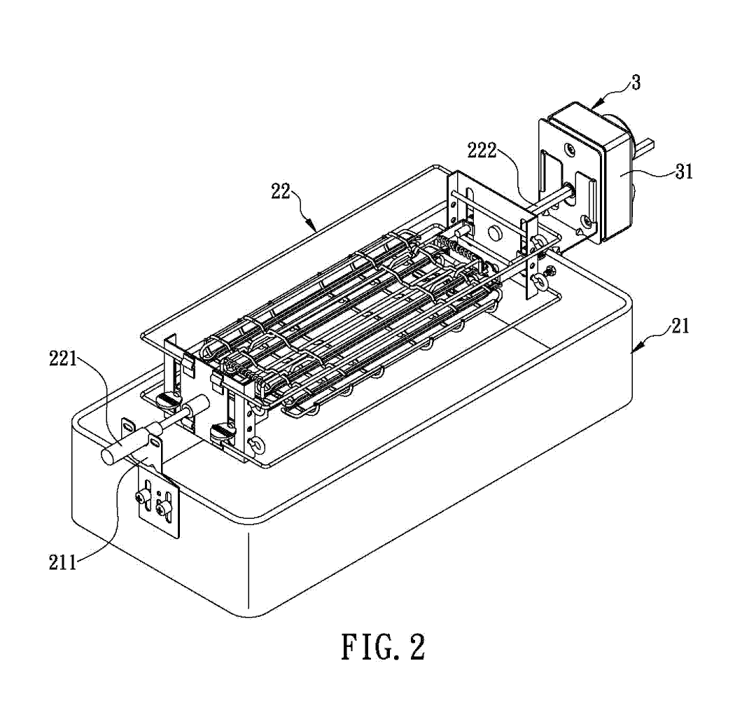

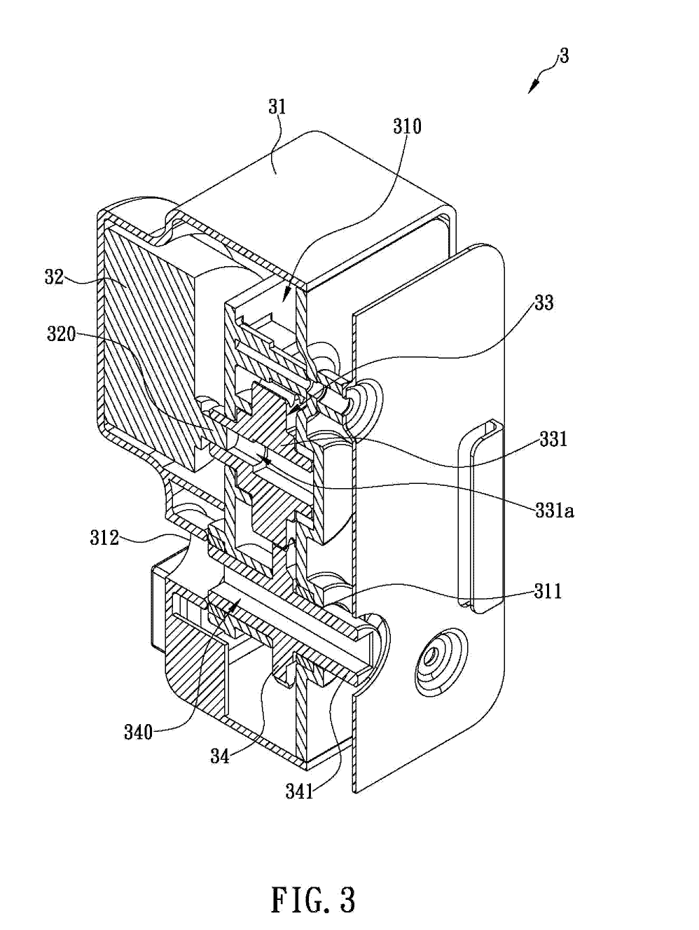

The present invention discloses a through-type barbecue driving device allowing arbitrary adjustment of the installation position of a rotating rod. Referring to FIG. 2 and FIG. 3 for the first preferred embodiment of the present invention, the through-type barbecue driving device 3 is applied to a barbecue stove 21 and includes a housing 31, a motor 32, a drive gear set 33, and an output gear 34. The housing 31 defines a receiving space 310 therein and is fixedly installed at a top edge on one side of the barbecue stove 21. The side of the housing 31 that faces the barbecue stove 21 is formed with a first through hole 311. The opposite side of the housing 31 is provided with a second through hole 312 corresponding in position to the first through hole 311. The through holes 311 and 312 are in communication with the receiving space 310.

The motor 32 is positioned in the receiving space 310 and adjacent to the through holes 311 and 312 and is provided with an output shaft 320 at one side. The drive gear set 33 at least includes a drive gear 331 whose axle is provided with a connecting portion 331a. The connecting portion 331a is connected with the output shaft 320 so that, when the motor 32 is in operation, the output shaft 320 drives the drive gear 331 to rotate. In this embodiment, the connecting portion 331a is a concave groove configured for engaging with the output shaft 320. In other embodiments of the present invention, however, the connecting portion 331a may be a threaded connecting portion configured for connecting with the output shaft 320 in a threaded manner.

As shown in FIG. 2 and FIG. 3, the output gear 34 is positioned in the receiving space 310 and is adjacent to the drive gear set 33 so as to mesh with the drive gear 331. The output gear 34 has a gear shaft 341 axially penetrated by a through groove 340. The through groove 340 and the gear shaft 341 correspond in position to the first through hole 311 and the second through hole 312 and match the rotating rod 222 of a metal frame 22 in terms of configuration. The rotating rod 222 can pass sequentially through the first through hole 311, the through groove 340, and the second through hole 312 and engage with the through groove 340. When the through-type barbecue driving device 3 starts operation, the output shaft 320 of the motor 32 drives the drive gear set 33 and the output gear 34 sequentially; as a result, the rotating rod 222 is rotated with the output gear 34 and above the barbecue stove 21.

Now that the rotating rod 222 passes through the output gear 34, the user, upon finding a mismatch in size between the rotating rod 222 and the barbecue stove 21, can readily adjust the position of the rotating rod 222 relative to the through groove 340, e.g., by extending an excessively long portion of the rotating rod 222 out of the housing 31 through the second through hole 312 such that the remaining portion of the rotating rod 222 has an appropriate length and is positioned above the barbecue stove 21, allowing the food in the metal frame 22 to be heated evenly above the barbecue stove 21. This adjusting mechanism makes it possible to apply the through-type barbecue driving device 3 of the present invention to barbecue stoves 21 of various sizes and specifications.

It should be pointed out that the drive gear set 33 in FIG. 3 includes nothing other than the drive gear 331 and that the drive gear 331 directly meshes with the output gear 34 in order to drive the output gear 34. In other preferred embodiments of the present invention, however, the drive gear 331 may be so designed that it drives the output gear 34 in an indirect manner, e.g., through another gear. That is to say, according to design requirements (e.g., in order to generate a higher torsion), the drive gear set 33 may include a plurality of gears in addition to the drive gear 331 such that the drive gear 331 meshes with the output gear 34 indirectly through the additional gears.

Referring to FIG. 2 and FIG. 3, the barbecue stove 21 in the present embodiment is also provided with a supporting element 211 and the aforementioned metal frame 22. The supporting element 211 is located on the side of the barbecue stove 21 that is opposite the side with the through-type barbecue driving device 3. The metal frame 22 is provided with a positioning rod 221 at one end and is connected to the rotating rod 222 at the opposite end. (In this embodiment, the rotating rod 222 is fixedly provided on the metal frame 22.) The positioning rod 221 matches the supporting element 211 in configuration in order to be supported by the supporting element 211, thus allowing the metal frame 22 to be positioned between the through-type barbecue driving device 3 and the supporting element 211, and the food in the metal frame 22 to correspond in position to the heat source in the barbecue stove 21. However, the structure of the barbecue stove 21 is not limited to the foregoing. For example, a much longer rotating rod 222 may be provided, wherein the rotating rod 222 has one end passing through the through-type barbecue driving device 3 and the opposite end extending all the way to the supporting element 211. In that case, food can be skewered on the rotating rod 222 and roasted without using the metal frame 22.

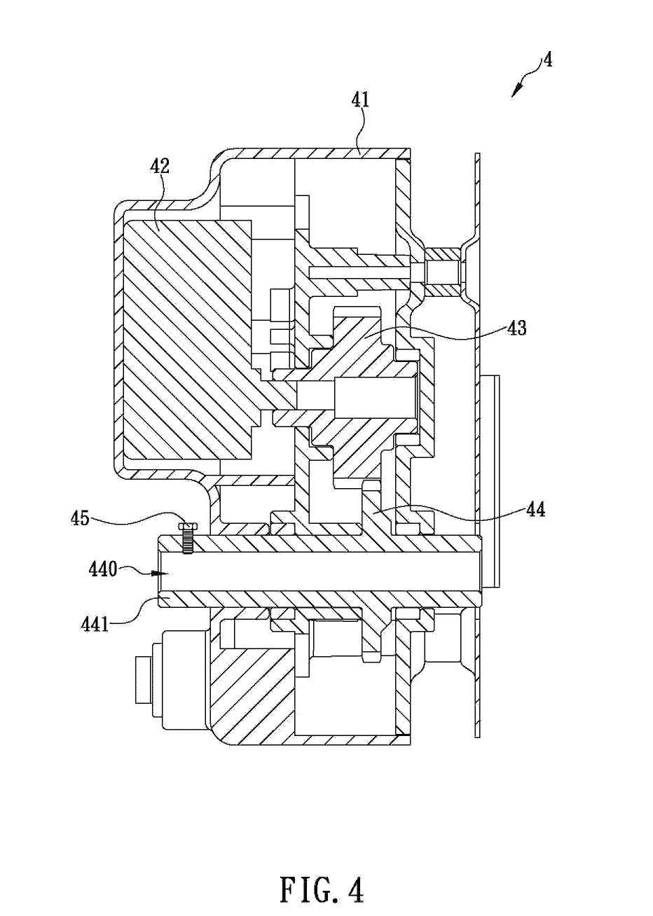

In the embodiment described above, both the rotating rod 222 and the through groove 340 have polygonal (e.g., rectangular) cross-sectional shapes, and the through groove 340 matches the rotating rod 222 in configuration in order for the rotating rod 222 to engage in the through groove 340 and rotate with the output gear 34. However, the rotating rod 222 does not have to be positioned in this way. Referring to FIG. 4 for the second preferred embodiment of the present invention, the through-type barbecue driving device 4 includes a positioning element 45 in addition to the housing 41, the motor 42, the drive gear set 43, and the output gear 44. The gear shaft 441 of the output gear 44 has its two ends passing through the first through hole and the second through hole respectively and exposed from the housing 41. One of the two end portions of the gear shaft 441 that are exposed from the housing 41 is provided with a threaded hole through which the positioning element 45 can be threadedly fixed to the gear shaft 441. Moreover, one end of the positioning element 45 can pass through the threaded hole of the gear shaft 441 and press against the rotating rod (not shown in FIG. 4) to fix the rotating rod in position. Thus, the positioning element 45 keeps the rotating rod from getting loose and thereby prevents the food being barbecued from shifting away from the heat source.

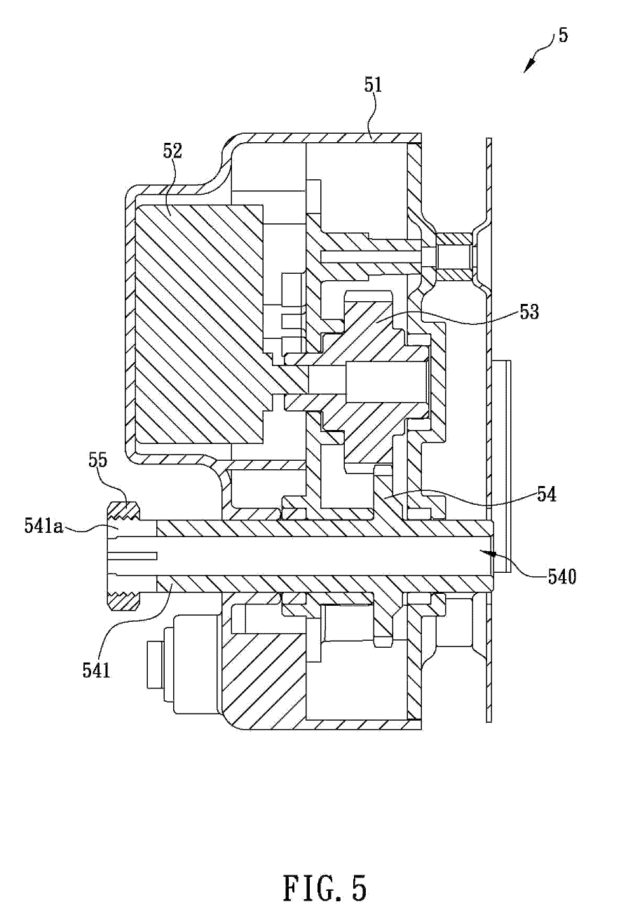

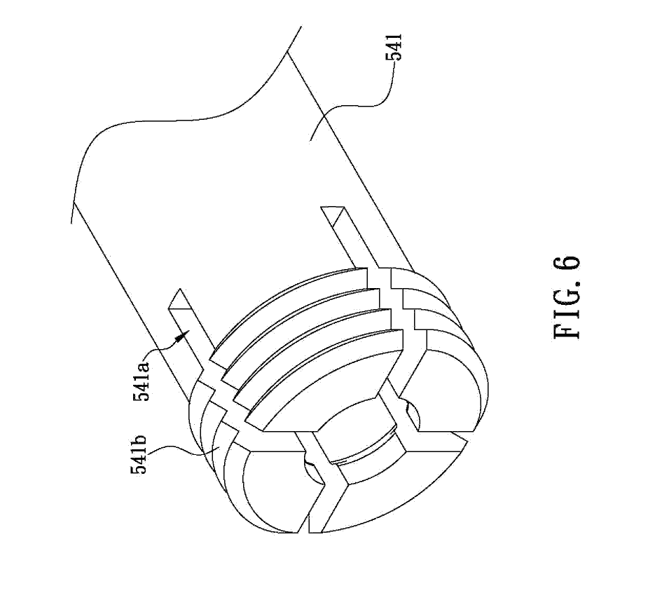

The configuration and positioning method of the positioning element 45 are not limited to the above. In the third preferred embodiment of the present invention as shown in FIG. 5 and FIG. 6, the through-type barbecue driving device 5 also includes a housing 51, a motor 52, a drive gear set 53, an output gear 54, and a positioning element 55, wherein the components other than the positioning element 55 have the same structures as their counterparts in the previous embodiments and therefore will not be described repeatedly. In this embodiment, the positioning element 55 is configured as a ring with a threaded inner periphery, and one of the two end portions of the gear shaft 541 that are exposed from the housing 51 is axially formed with a plurality of slots 541a and is provided with external threads 541b corresponding in position to the slots 541a. After the rotating rod passes through the through groove 540, the end portion of the gear shaft 541 that is exposed from the housing 51 and provided with the slots 541a tightly grips the rotating rod. When the positioning element 55, which is threadedly mounted around this exposed end portion of the gear shaft 541, is tightened, the exposed end portion is further tightened around the rotating rod to effectively fix the rotating rod in position.

While the invention herein disclosed has been described by means of specific embodiments, numerous modifications and variations could be made thereto by those skilled in the art without departing from the scope of the invention set forth in the claims.

What is claimed is:

1. A through-type barbecue driving device allowing arbitrary adjustment of an installation position of a rotating rod, applicable to a barbecue stove, the through-type barbecue driving device comprising:
a housing fixedly installed at a top edge on a side of the barbecue stove, the housing defining a receiving space therein, the housing having a side which faces the barbecue stove and which is formed with a first through hole, the housing having an opposite side provided with a second through hole corresponding in position to the first through hole, wherein the first through hole and the second through hole are in communication with the receiving space;
a motor positioned in the receiving space and having an end provided with an output shaft;
a drive gear set positioned in the receiving space and comprising a drive gear, the drive gear having an axle provided with a connecting portion, the connecting portion being connected with the output shaft so that the output shaft drives the drive gear to rotate when the motor is in operation; and
an output gear positioned in the receiving space and adjacent to the drive gear set so as to mesh with the drive gear set, the output gear having a gear shaft axially penetrated by a through groove, the through groove corresponding in position to the first through hole and the second through hole and matching a rotating rod in configuration so that the rotating rod can pass sequentially through the first through hole, the through groove, and the second through hole and engage with the through hole, wherein when the through-type barbecue driving device begins operation, the output shaft of the motor sequentially drives the drive gear set and the output gear and thereby drives the rotating rod to rotate above the barbecue stove.

2. The through-type barbecue driving device of claim 1, wherein the gear shaft passes through the first through hole or the second through hole to be exposed from the housing.

3. The through-type barbecue driving device of claim 2, further comprising a positioning element to be threadedly fixed to a portion of the gear shaft that is exposed from the housing, wherein the positioning element has an end configured for pressing against the rotating rod.

4. The through-type barbecue driving device of claim 2, wherein the gear shaft has a portion exposed from the housing and axially formed with a plurality of slots in order for the portion of the gear shaft that is exposed from the housing to tightly grip the rotating rod.

5. The through-type barbecue driving device of claim 4, further comprising a positioning element to be threadedly mounted around and fixed to the portion of the gear shaft that is exposed from the housing in order for the portion of the gear shaft that is exposed from the housing to tightly grip the rotating rod.

6. The through-type barbecue driving device of claim 1, wherein each of the through groove and the rotating rod has a polygonal cross-sectional shape.

7. The through-type barbecue driving device of claim 2, wherein each of the through groove and the rotating rod has a polygonal cross-sectional shape.

8. The through-type barbecue driving device of claim 3, wherein each of the through groove and the rotating rod has a polygonal cross-sectional shape.

9. The through-type barbecue driving device of claim 4, wherein each of the through groove and the rotating rod has a polygonal cross-sectional shape.

10. The through-type barbecue driving device of claim 5, wherein each of the through groove and the rotating rod has a polygonal cross-sectional shape.

11. The through-type barbecue driving device of claim 6, wherein the connecting portion is configured as a concave groove, and the concave groove matches the output shaft in configuration so as to connect with the output shaft.

12. The through-type barbecue driving device of claim 7, wherein the connecting portion is configured as a concave groove, and the concave groove matches the output shaft in configuration so as to connect with the output shaft.

13. The through-type barbecue driving device of claim 8, wherein the connecting portion is configured as a concave groove, and the concave groove matches the output shaft in configuration so as to connect with the output shaft.

14. The through-type barbecue driving device of claim 9, wherein the connecting portion is configured as a concave groove, and the concave groove matches the output shaft in configuration so as to connect with the output shaft.

15. The through-type barbecue driving device of claim 10, wherein the connecting portion is configured as a concave groove, and the concave groove matches the output shaft in configuration so as to connect with the output shaft.
